(19) United States
(12) Patent Application Publication
(10) Pub. No.: US 2002/0028755 A1
(43) Pub. Date: Mar. 7, 2002

(54) Liquid detergent composition

(75) Inventors: Willem Robert Van Dijk, Vlaardingen (NL); Theresia Maria Olsthoorn, Vlaardingen (NL); Marja Ouwendijk, Hellevoetsluis (NL); Johannes Cornelis Van De Pas, Vlaardingen (NL)

Correspondence Address: UNILEVER, PATENT DEPARTMENT, 45 RIVER ROAD, EDGEWATER, NJ, 07020, US

(73) Assignee: Unilever Home & Personal Care USA, Division of Conopco, Inc.

(21) Appl. No.: 09/880,238

(22) Filed: Jun. 13, 2001

(30) Foreign Application Priority Data
Jun. 15, 2000 (EP) 00202092.3

(51) Int. Cl. C11D 3/386; C11D 7/42

(52) U.S. Cl. 510/392; 510/530; 510/470

(57) ABSTRACT

A liquid detergent composition comprising

(a) from 1 to 90% of an anionic, nonionic, cationic, zwitterionic active detergent material or mixtures thereof,

(b) from 0.001 to 10% of dissolved or dispersed protease;

said composition further comprising a protease stabilisation system wherein said system comprises

(c) from 2 to 40% of at least one saccharide selected from the group consisting of disaccharides and trisaccharides, derivatives thereof and mixtures thereof.

### FIELD OF THE INVENTION

The present invention is concerned with a liquid detergent composition in which a protease is stabily incorporated and a method to stabilise a protease in a liquid detergent composition.

### BACKGROUND OF THE INVENTION

Proteolytic enzyme is advantageously employed in detergent compositions for the cleaning of fabrics. However, it is a problem is to ensure a sufficient storage-stability of the enzyme when it has to be incorporated in a concentrated liquid detergent composition. The prior art has already described various ways in which this problem can be overcome, e.g. by encapsulating the enzymes or by inclusion of enzyme-stabilising systems in such liquid detergent compositions. For example, glycerol/borax is a well-known enzyme stabilising system. Unfortunately, glycerol/borax is a rather costly system. Enzyme encapsulates are complex to prepare and consequently rather expensive. An additional problem is that enzyme stabilising systems add complexity to the liquid detergent formulation. Especially concentrated liquid detergent compositions are difficult to formulate in such a way that the composition remains stable over a prolonged period of time.

WO-A-98/40471 describes a method to improve the storage stability of dissolved laccase, an enzyme that catalyses the oxidation of phenol of which the reaction products can be used for dyeing hair or fabrics. The laccase is dissolved in water and sorbitol. There is no mention of saccharides or liquid detergent compositions for the cleaning of fabrics.

U.S. Pat. No. 5,288,746 relates to liquid laundry detergent composition wherein glucose and glucose oxidase are used for the generation of hydrogen peroxide. To decrease premature hydrogen peroxide generation in the composition Cu2+ or Ag+ ions are incorporated in the composition. Therefore, glucose is not used as enzyme stabilising system but as a substrate for the enzyme. There is no mention of the effect of di- or trisaccharides on protease stability.

WO-A-97/25397 discloses liquid dishwashing compositions. There is an example in this disclosure containing protease enzyme and sucrose. However, the amount of sucrose is only 1.5% by weight of the composition, which is below the effective enzyme stabilizing amount required for the compositions according to the present invention.

DE-A-20 15 504 discloses an enzymatic product suitable for incorporation in detergent products. A water soluble saccharide is included in the product. In two examples, this saccharide is either saccharose, or respectively, lactose. However, if incorporated into a liquid detergent product at a level sufficient to have effective enzymatic cleaning, the amount of the saccharide in those examples is too low to have an effective enzyme stabilising effect.

DE 20 38 103 discloses a phosphate-containing dishwashing composition which contains no surfactant. According to claim 1 of this document, one optional component is a disaccharide. However, there is no example of this. Moreover, there is no suggestion that a disaccharide would have any enzyme stabilising ability in a surfactant-containing composition. Surfactant-containing compositions present an environment where enzyme stabilisation is a much more difficult problem to solve.

EP-A-586 741 mentions a contact lens cleaning system comprising two solutions. As enzyme stabilizers, a number of polyols and saccharides are mentioned, including maltose. However, there is no example containing the latter material. Moreover, the person skilled in the art of formulating laundry or household cleaning products would not think to extrapolate from this teaching to the present invention.

U.S. Pat. No. 4,238,345 discloses a liquid enzyme-containing aqueous liquid detergent composition. Polyol mentioned as enzyme stabilizing components. To that extent, the definition could encompass saccharides. However, the maximum number of hydroxyl groups specified means that according to this definition, they could only be monosaccharides.

U.S. Pat. No. 4,462,922 describes a liquid detergent wherein a mixture of glycerol, boron compound and an antioxidant containing sulphur is used to produce an enzyme-stabilising effect. For this mixture the antioxidant must be present above a certain level, as well as the boric acid or the alkalimetalborate. The antioxidant should be present in the mixture in an amount of at least 5% by weight of the final enzymatic aqueous liquid detergent composition, and the boric acid or alkalimetalborate in an amount of at least 2% by weight of the final enzymatic aqueous liquid detergent composition. The antioxidant is an alkalimetalsulphites, alkalimetalbisulphites, alkalimetabisulphites or alkalimetalthiosulphates.

However, this prior art composition is less desirable because sulphite salts tend to produce an unpleasant odour. Furthermore, applicants have found that it is problematic to incorporate the enzyme stabilising system of U.S. Pat. No. 4,462,922 in a concentrated liquid detergent composition because this leads to a liquid which is no longer physically stable. In addition, sulphite salts have a bleaching effect and can damage colored fabrics. Surprisingly, we have now found that one or more of these problems can be overcome by the present invention while maintaining a good protease stability.

### DEFINITION OF THE INVENTION

Accordingly, the present invention provides a liquid detergent composition comprising

(a) from 1 to 90% of an anionic, nonionic, cationic, zwitterionic active detergent material or mixtures thereof,

(b) from 0.001 to 10% of dissolved or dispersed protease;

said composition further comprising a protease stabilisation system wherein said system comprises

(c) from 2 to 40% of at least one saccharide selected from the group consisting of disaccharides and trisaccharides, a derivative thereof and mixtures thereof.

The invention further encompasses a method for the stabilisation of protease in a physically stable liquid detergent composition comprising the steps of

(I) formulating said composition comprising

(a) from 1 to 90% of an anionic, nonionic, cationic, zwitterionic active detergent material or mixtures thereof,

(b) from 0.0001% to 10% of dissolved or dispersed protease; and

(II) adding 2 to 40% of at least from 2 to 40% of at least one saccharide selected from the group consisting of disaccharides and trisaccharides, derivatives thereof and mixtures thereof to the composition prepared in step (I).

One of the advantages of the present invention is that it provides a stable detergent composition that is simple to formulate and offers a significant cost advantage compared to glycerol/borax system.

A further advantage of the inventive composition is that composition can be formulated wherein the saccharide can be incorporated up to at least 40 wt % without causing physical stability problems.

### Saccharide

Saccharides used in the present invention are selected from the group comprising the disaccharides and trisaccharides as well as molecules derived from these saccharides by reduction of the carbonyl group (alditols), by oxidation of one or more hydroxyl groups to carboxylic acids (uronic acids, aldonic acids and ketoaldonic acids) or by replacement of one or more hydroxy groups(s) by a hydrogen atom (deoxy sugars), an amino group (amino sugars), a thiol group or other heteroatomic groups. It should be understood that when the term saccharides is used in the context of the present invention it preferably includes the above mentioned derivatives.

One preferred saccharide is selected from the group comprising trisaccharides with a free hemiacetal group. Typical examples of this category are: Cellotriose (β-D-glucopyranosyl-(1→4)-β-D-glucopyranosyl-(1→4)-D-glucopyranose. Even more preferred are the trisaccharides without a free hemiacetal group (the so-called non-reducing trisaccharides). Typical example of this category is raffinose (β-D-Fructofuranosyl α-D-galactopyranosyl-(1→6)-α-D-glucopyranoside).

The most preferred saccharide comprises the disaccharides of non-mammalian origin. This does not include milk sugar lactose. More specifically the disaccharides with a free hemiacetal group (the so-called reducing disaccharides. Typical examples of this category are: Cellobiose (β-D-glucopyranosyl-(1→4)-D-glucose)β-maltose (α-D-glucopyranosyl-(1→4)-β-D-glucopyranose).

The most preferred disaccharides are compounds without a free hemiacetal group (the so-called non-reducing disaccharides. Typical disaccharides of the last category, are: Sucrose (β-D-Fructofuranosyl α-D-glucopyranoside) Trehalose (α-D-Glucupyranosyl α-D-glucopyranoside).

The composition herein preferably comprise 5-30%, more preferably 8-25% of at least one saccharide.

### Additional Enzyme Stabilising System

In most cases the inventive composition will not need an additional measure to stabilise the enzyme. However, if needed small amounts of additional stabilising systems can be added, for example, those comprising, boric acid, propylene glycol, short chain carboxylic acids, boronic acids, and mixtures thereof, designed to address different stabilization problems depending on the type and physical form of the detergent composition.

Another stabilizing approach is by use of borate species. See Severson, U.S. Pat. No. 4,537,706. Borate stabilizers, when used, are preferably present in an amount of more than 0.1 and less than 5%, preferably less than 3%, more preferably less than 2.5% by weight of boric acid. Other borate compounds may be used such as borax or orthoborate suitable for liquid detergent use. Substituted boric acids such as phenylboronic acid, butaneboronic acid, p-bromophenylboronic acid or the like can be used in place of boric acid and reduced levels of total boron in detergent compositions may be possible though the use of such substituted boron derivatives.

### Enzymes

“Detersive enzyme”, as used herein, means any enzyme having a cleaning, stain removing or otherwise beneficial effect in a laundry application. Enzymes are included in the present detergent compositions for a variety of purposes, including removal of protein-based, saccharide-based, or triglyceride-based stains, for the prevention of refugee dye transfer, and for fabric restoration. Suitable enzymes include proteases, amylases, lipases, cellulases, peroxidases, and mixtures thereof of any suitable origin, such as vegetable, animal, bacterial, fungal and yeast origin. Preferred selections are influenced by factors such as pH-activity and/or stability optima, thermostability, and stability to active detergents, builders and the like. In this respect bacterial or fungal enzymes are preferred, such as bacterial amylases and proteases, and fungal cellulases.

Enzymes in general, e.g. proteases, are normally incorporated into detergent or detergent additive compositions at levels sufficient to provide a “cleaning-effective amount”. The term “cleaning effective amount” refers to any amount capable of producing a cleaning, stain removal, soil removal, whitening, deodorizing, or freshness improving effect on substrates such as fabrics. In practical terms for current commercial preparations, typical amounts are up to about 5 mg by weight, more typically 0.01 mg to 3 mg, of active enzyme per gram of the detergent composition. Stated otherwise, the compositions herein will typically comprise from 0.0001% to 10%, preferably from 0.001% to 5%, more preferably 0.005%-1% by weight of a commercial enzyme preparation.

The protease enzymes of the present invention are usually present in such commercial preparations at levels sufficient to provide from 0.005 to 0.1 Anson units (AU) of activity per gram of composition. It should be understood that the protease is present in the liquid detergent composition in a dissolved or dispersed form, i.e., the protease is not encapsulated to prevent the protease from the liquid composition. Instead the protease in more or less in direct contact with the liquid composition.

Protease enzymes are usually present in such commercial preparations at levels sufficient to provide from 0.005 to 0.1 Anson units (AU) of activity per gram of composition.

Suitable examples of proteases are the subtilisins which are obtained from particular strains of B. subtilis and B. licheniformis. One suitable protease is obtained from a strain of Bacillus, having maximum activity throughout the pH range of 8-12, developed and sold as ESPERASE™ by Novo Industries A/S of Denmark, hereinafter “Novo”. The preparation of this enzyme and analogous enzymes is described in GB 1,243,784 to Novo. Other suitable proteases include ALCALASE™ and SAVINASE™ from Novo and MAXATASE™ from International Bio-Synthetics, Inc., The Netherlands; as well as Protease A as disclosed in EP 130,756 A, and Protease B as disclosed in EP 303,761 A and EP 130,756 A. See also a high pH protease from Bacillus sp. NCIMB 40338 described in WO 9318140 A to Novo. Enzymatic detergents comprising protease, one or more other enzymes, and a reversible protease inhibitor are described in WO 9203529 A. Other preferred proteases include those of WO 9510591 A. When desired, a protease having decreased adsorption and increased hydrolysis is available as described in WO 9507791. A recombinant trypsin-like protease for detergents suitable herein is described in WO 9425583.

Useful proteases are also described in PCT publications: WO 95/30010, WO 95/30011, WO 95/29979.

Preferred proteolytic enzymes are also modified bacterial serine proteases, such as those described in EP-A-251446 (particularly pages 17, 24 and 98), and which is called herein “Protease B”, and in EP-A-199404, which refers to a modified bacterial serine proteolytic enzyme which is called “Protease A” herein, Protease A as disclosed in EP-A-130756.

Amylases suitable herein include, for example, alfa-amylases described in GB 1,296,839 to Novo; RAPIDASE™, International Bio-Synthetics, Inc. and TERMAMYL™, Novo. FUNGAMYL™ from Novo is especially useful.

See, for example, references disclosed in WO 9402597. Stability-enhanced amylases can be obtained from Novo or from Genencor International. One class of highly preferred amylases herein have the commonality of being derived using site- directed mutagenesis from one or more of the Baccillus amylases, especialy the Bacillus cc-amylases, regardless of whether one, two or multiple amylase strains are the immediate precursors.

Oxidative stability-enhanced amylases vs. the above-identified reference amylase are preferred for use, especially in bleaching, more preferably oxygen bleaching, as distinct from chlorine bleaching, detergent compositions herein. Such preferred amylases include (a) an amylase according to WO 9402597, known as TERMAMYL™,

Particularly preferred amylases herein include amylase variants having additional modification in the immediate parent as described in WO 9510603 A and are available from the assignee, Novo, as DURAMYL™. Other particularly preferred oxidative stability enhanced amylase include those described in WO 9418314 to Genencor International and WO 9402597 to Novo Or WO 9509909 A to Novo.

Cellulases usable herein include both bacterial and fungal types, preferably having a pH optimum between 5 and 9.5. U.S. Pat. No. 4,435,307 discloses suitable fungal cellulases from Humicola insolens or Humicola strain DSM1800 or a cellulase 212-producing fungus belonging to the genus Aeromonas, and cellulase extracted from the hepatopancreas of a marine mollusk, Dolabella Auricula Solander. Suitable cellulases are also disclosed in GB-A-2.075.028; GB-A-2.095.275 and DE-OS-2.247.832. CAREZYME™ (Novo) is especially useful. See also WO 9117243.

Suitable lipase enzymes for detergent usage include those produced by 30 microorganisms of the Pseudomonas group, such as Pseudomonas stutzeri ATCC 19.154, as disclosed in GB 1,372,034. See also lipases in Japanese Patent Application 53,20487. This lipase is available from Amano Pharmaceutical Co. Ltd., Nagoya, Japan, under the trade name Lipase P “Amano,” or “Amano-P.” Other suitable commercial lipases include Amano-CES, lipases ex Chromobacter viscosum, e.g. Chromobacter viscosum var. lipolyticum NRRLB 3673 from Toyo Jozo Co., Tagata, Japan; Chromobacter viscosum lipases from U.S. Biochemical Corp., U.S.A. and Disoynth Co., The Netherlands, and lipases ex Pseudomonas gladioli. LIPOLASE™ enzyme derived from Humicola lanyginosa and commercially available from Novo, see also EP 341,947, is a preferred lipase for use herein. Lipase and amylase variants stabilized against peroxidase enzymes are described in WO 9414951 A to Novo. See also WO 9205249. Cutinase enzymes suitable for use herein are described in WO 8809367 A to Genencor.

The preferred liquid laundry detergent compositions according to the present invention further comprise at least 0.001% by weight, of a protease enzyme. However, an effective amount of protease enzyme is sufficient for use in the liquid laundry detergent compositions described herein. The term “an effective amount” refers to any amount capable of producing a cleaning, stain removal, soil removal, whitening, deodorizing, or freshness improving effect on substrates such as fabrics. In practical terms for current commercial preparations, typical amounts are up to about 5 mg by weight, more typically 0.01 mg to 3 mg, of active enzyme per gram of the detergent composition. Stated otherwise, the compositions herein will typically comprise from 0.001% to 5%, preferably 0.01%-1% by weight of a commercial enzyme preparation.

Peroxidase enzymes may be used in combination with oxygen sources, e.g., percarbonate, perborate, hydrogen peroxide, etc., for “solution bleaching” or prevention of transfer of dyes or pigments removed from substrates during the wash to other substrates present in the wash solution. Known peroxidases include horseradish peroxidase, ligninase, and haloperoxidases such as chloro- or bromo-peroxidase.

Peroxidase-containing detergent compositions are disclosed in WO 89099813 A, Oct. 19, 1989 to Novo and WO-A-8909813.

A range of enzyme materials and means for their incorporation into synthetic detergent compositions is also disclosed in WO-A-9307263 and WO -A-307260 to Genencor International, WO-A-8908694 and U.S. Pat. No. 3,553,139.

### Liquid Detergent Composition

### Product Form

The liquid detergent composition according the present invention is preferably a concentrated liquid detergent composition. In one aspect of the invention the liquid detergent composition is isotropic. In another aspect of the invention the liquid detergent composition is structured. It should be understood that the liquid compositions according to any aspect of the present invention have a physical form which preferably ranges from a pourable liquid, a pourable gel to a non-pourable gel. These forms are conveniently characterised by the product viscosity. In these definitions, and unless indicated explicitly to the contrary, throughout this specification, all stated viscosities are those measured at a shear rate of 21 s⁻¹ and at a temperature of 25° C.

Compositions according to any aspect of the present invention which are liquids, preferably have a viscosity of no more than 1,500 mPa.s, more preferably no more than 1,000 mPa.s, still more preferably, no more than 500 mPa.s.

Compositions according to any aspect of the present invention which are pourable gels, preferably have a viscosity of at least 1,500 mPa.s but no more than 6,000 mPa.s, more preferably no more than 4,000 mPa.s, still more preferably no more than 3,000 mPa.s and especially no more than 2,000 mPa.s.

Compositions according to any aspect of the present invention which are non-pourable gels, preferably have a viscosity of at least 6,000 mPa.s but no more than 12,000 mPa.s, more preferably no more than 10,000 mPa.s, still more preferably no more than 8,000 mPa.s and especially no more than 7,000 mPa.s.

### pH

The detergent compositions herein will preferably be formulated such that, during use in aqueous cleaning operations, the wash water will have a pH of between about 6.0 and about 11, preferably between about 7.0 and 10.0. Laundry liquid products are typically at pH 7-9. Techniques for controlling pH at recommended usage levels include the use of buffers, alkalis, acids, etc., and are well known to those skilled in the art.

### Physically Stable

For the purpose of this invention a composition is physically stable when less than 2% phase separation occurs after 2 week storage at 37° C. With isotropic liquids this phase separation generally starts with the liquid becoming hazy.

### Water

Preferably the amount of water in the liquid detergent composition is from 5 to 95%, more preferred from 25 to 75%, most preferred from 30 to 50%. Especially preferred less than 45% by weight.

### I Isotropic Liquid Detergent Compositions

Isotropic liquid detergent composition are defined for the present purpose as liquid detergent compositions wherein the surfactants do not form liquid crystalline phases, like multi-lamellar droplets of surfactant material. Isotropic liquids are generally not birefringent under static conditions but may be birefringent under flow.

### Ia Surfactant

The isotropic compositions herein comprise from 1 to 90%,preferably from 10 to 70% by weight of an anionic, nonionic, cationic, zwitterionic active detergent material or mixtures thereof. Preferably the compositions herein comprise 12 to 60% of surfactant, more preferably 15 to 40%.

Non-limiting examples of other surfactants useful herein typically at levels from about 10% to about 70%, by weight, include the conventional C11-C18 alkylbenzene sulphonates (“LAS”), the C10-C18 secondary (2,3) alkyl sulphates of the formula CH3(CH2)ₓ(CHOS03-M+)CH3 and CH3(CH2)_{y}(CHOS03-M+)CH2CH3 where x and (y+1) are integers of at least about 7, preferably at least about 9, and M is a water-solubilising cation, especially sodium, unsaturated sulphates such as oleyl sulphate, C10-C18 alkyl alkoxy carboxylates (especially the EO 1-7 ethoxycarboxylates), the C10-C18 glycerol ethers, the C10-C18alkyl polyglycosides and their corresponding sulphated polyglycosides, and C12-C18 alpha-sulphonated fatty acid esters. If desired, the conventional nonionic and amphoteric surfactants such as the C12-C18 alkyl ethoxylates (“AE”) including the so-called narrow peaked alkyl ethoxylates and C6-C12 alkyl phenol alkoxylates (especially ethoxylates and mixed ethoxy/propoxy), C12-C18 betaines and sulphobetaines (“sultaines”), C10-C18 amine oxides, and the like, can also be included in the overall compositions. The C10-C18 N-alkyl polyhydroxy fatty acid amides can also be used. Typical examples include the C12-C18 N-methylglucamides. See WO 9,206,154. Other sugar-derived surfactants include the N-alkoxy polyhydroxy fatty acid amides, such as C10-C18 N-(3-methoxypropyl) glucamide. C10-C20 conventional soaps may also be used. If high sudsing is desired, the branched-chain C10-C16 soaps may be used.

Mixtures of anionic and nonionic surfactants are especially useful. Other conventional useful surfactants are listed in standard texts.

Other anionic surfactants useful for detersive purposes can also be included in the isotropic compositions hereof. These can include salts (including, for example, sodium potassium, ammonium, and substituted ammonium salts such a mono-, di- and triethanolamine salts) of soap, C9-C20 linear alkylbenzenesulphonates, C8-C22 primary or secondary alkanesulphonates, C8-C24 olefinsulphonates, sulphonated polycarboxylic acids, alkyl glycerol sulphonates, fatty acyl glycerol sulphonates, fatty oleyl glycerol sulphates, alkyl phenol ethylene oxide ether sulphates, paraffin sulphonates, alkyl phosphates, isothionates such as the acyl isothionates, N-acyl taurates, fatty acid amides of methyl tauride, alkyl succinamates and sulphosuccinates, monoesters of sulphosuccinate (especially saturated and unsaturated C12-C18 monoesters) diesters of sulphosuccinate (especially saturated and unsaturated C6-C14 diesters), N-acyl sarcosinates, sulphates of alkylpolysaccharides such as the sulphates of alkylpolyglucoside, branched primary alkyl sulphates, alkyl polyethoxy carboxylates such as those of the formula RO(CH2CH20)ₖCH2COO-M+ wherein R is a C8-C22 alkyl, k is an integer from 0 to 10, and M is a soluble salt-forming cation, and fatty acids esterified with isethionic acid and neutralised with sodium hydroxide. Further examples are given in Surface Active Agents and Detergents (Vol. I and II by Schwartz, Perry and Berch).

The isotropic compositions of the present invention preferably comprise at least about 5%, preferably at least 10%, more preferably at least 12% and less than 70%, more preferably less than 60% by weight, of an anionic surfactant.

Alkyl sulphate surfactants, either primary or secondary, are a type of anionic surfactant of importance for use herein. Alkyl sulphates have the general formula ROS03M wherein R preferably is a C10-C24 hydrocarbyl, preferably an alkyl straight or branched chain or hydroxyalkyl having a C10-C20 alkyl component, more preferably a C12-C18 alkyl or hydroxyalkyl, and M is hydrogen or a water soluble cation, e.g., an alkali metal cation (e.g., sodium potassium, lithium), substituted or unsubstituted ammonium cations such as methyl-, dimethyl-, and trimethyl ammonium and quaternary ammonium cations, e.g., tetramethyl-ammonium and dimethyl piperdinium, and cations derived from alkanolamines such as ethanolamine, diethanolamine, triethanolamine, and mixtures thereof, and the like.

Typically, alkyl chains Of C12-C16 are preferred for lower wash temperatures (e.g., below about 50° C. and C16-C18 alkyl chains are preferred for higher wash temperatures (e.g., about 50° C.).

Alkyl alkoxylated sulphate surfactants are another category of preferred anionic surfactant. These surfactants; are water soluble salts or acids typically of the formula RO(A)mSO3M wherein R is an unsubstituted C10-C24 alkyl or hydroxyalkyl group having a C10-C24 alkyl component, preferably a C12-C20 alkyl or hydroxyalkyl, more preferably C12-C18 alkyl or hydroxyalkyl, A is an ethoxy or propoxy unit, m is greater than zero, typically between about 0.5 and about 6, more preferably between about 0.5 and about 3, and M is hydrogen or a water soluble cation which can be, for example, a metal cation (e.g., sodium, potassium, lithium, calcium, magnesium, etc.), ammonium or substituted-ammonium cation. Alkyl ethoxylated sulphates as well as alkyl propoxylated sulphates are contemplated herein. Specific examples of substituted ammonium cations include methyl-, dimethyl-, trimethyl-ammonium and quaternary ammonium cations, such as tetramethyl-ammonium, dimethyl piperdinium and cations derived from alkanolamines, e.g., monoethanolamine, diethanolamine, and triethanolamine, and mixtures thereof. Exemplary surfactants are C12-C18 alkyl polyethoxylate (1.0) sulphate, C12-C18 alkyl polyethoxylate (2.25) sulphate, C12-C18 alkyl polyethoxylate (3.0) sulphate, and C12-C18 alkyl polyethoxylate (4.0) sulphate wherein M is conveniently selected from sodium and potassium.

The isotropic compositions of the present invention preferably comprise at least about 5%, preferably at least 10%, more preferably at least 12% and less than 70%, more preferably less than 60% by weight, of a nonionic surfactant.

Preferred nonionic surfactants such as C12-C18 alkyl ethoxylates (“AE”) including the so- called narrow peaked alkyl ethoxylates and C6-C12 alkyl phenol alkoxylates (especially ethoxylates and mixed ethoxy/propoxy), block alkylene oxide condensate of C6 to C12 alkyl phenols, alkylene oxide condensates of C8-C22 alkanols and ethylene oxide/propylene oxide block polymers (Pluronic™-BASF Corp.), as well as semi polar nonionics (e.g., amine oxides and phosphine oxides) can be used in the present isotropic compositions. An extensive disclosure of these types of surfactants is found in U.S. Pat. No. 3,929,678.

Alkylpolysaccharides such as disclosed in U.S. Pat. No.4,565,647 are also preferred nonionic surfactants in the isotropic compositions of the invention.

Further preferred nonionic surfactants are the polyhydroxy fatty acid amides.

A particularly desirable surfactant of this type for use in the isotropic compositions herein is alkyl-N-methyl glucamide.

Other sugar-derived surfactants include the N-alkoxy polyhydroxy fatty acid amides, such as C10-C18N-(3-methoxypropyl) glucamide. The N-propyl through N- hexyl C12-C18 glucamides can be used for low sudsing. C10-C20 conventional soaps may also be used. If high sudsing is desired, the branched-chain C10-C16 soaps may be used.

Another preferred anionic surfactant is a salt of fatty acids. Examples of fatty acids suitable for use of the present invention include pure or hardened fatty acids derived from palmitoleic, safflower, sunflower, soybean, oleic, linoleic, linolenic, ricinoleic, rapeseed oil or mixtures thereof. Mixtures of saturated and unsaturated fatty acids can also be used herein.

It will be recognised &at the fatty acid will be present in the liquid detergent isotropic composition primarily in the form of a soap. Suitable cations include, sodium, potassium, ammonium, monoethanol ammonium diethanol ammonium, triethanol ammonium, tetraalkyl ammonium, e.g., tetra methyl ammonium up to tetradecyl ammonium etc. cations.

The amount of fatty acid will vary depending on the particular characteristics desired in the final detergent isotropic composition. Preferably 0 to 30%, more preferably 1-20 most preferably 5-15% fatty acid is present in the inventive isotropic composition.

### Ib Carriers

Isotropic liquid detergent compositions can contain water and other solvents as carriers.

Low molecular weight primary or secondary alcohols exemplified by methanol, ethanol, propanol, and isopropanol are suitable. Monohydric alcohols are preferred for solubilising surfactant. The compositions may contain from 5% to 90%, typically 10% to 50% of such carriers.

### Ic Clarity

The clarity of the isotropic compositions according to the present invention does not preclude the isotropic composition being colored, e.g. by addition of a dye, provided that it does not detract substantially from clarity. Moreover, an opacifier could be included to reduce clarity if required to appeal to the consumer. In that case the definition of clarity applied to the isotropic composition according to any aspect of the invention will apply to the base (equivalent) isotropic composition without the opacifier.

### Structured Liquid Detergent Composition

Conventionally, liquid detergent compositions may be structured in one of two different ways to endow consumer-preferred flow behaviour and/or turbid appearance and/or of suspending particulate solids such as detergency builders or abrasive particles.

The first way is to employ an “external structurant” such as a gum or polymer thickener. The second way is to form a lamellar phase “internal structure” from the surfactant(s) and water, the latter usually containing dissolved electrolyte.

Lamellar phases are a particular class of surfactant structures which, inter alia, are already known from a variety of references, e.g. H. A. Barnes, ‘Detergents’, Ch. 2 in K. Walters (Ed), Rheometry: Industrial Applications', J. Wiley & Sons, Letchworth 1980.

Lamellar phases can themselves be considered as divided into the sub-classes planar lamellar phases and lamellar droplets. Products can contain exclusively planar lamellar phases or exclusively lamellar droplets or the two forms can co-exist in the same product.

The presence of lamellar phase s in a liquid detergent product may be detected by means known to those skilled in the art, for example optical techniques, various rheometrical measurements, X-ray or neutron diffraction, and electron microscopy.

Lamellar droplets consist of an onion-like configuration of concentric bi-layers of surfactant molecules, between which is trapped water or electrolyte solution (aqueous phase). Systems in which such droplets are close-packed provide a very desirable combination of physical stability and solid-suspending properties with useful flow properties.

Examples of internally structured liquids containing a dispersion of lamellar droplets but without suspended solids are given in U.S. Pat. No. 4,244,840, whilst examples where solid particles are suspended are disclosed in specifications EP-A-160 342:

EP-A-38 101: EP-A-104 452 and also in the aforementioned U.S. Pat. No. 4,244,840. Others are disclosed in European Patent Specification EP-A-151 884, where the lamellar droplets are called ‘spherulites’.

There are also known examples of products containing planar lamellar phases which may be extensive throughout the liquid or distributed as discrete layers interspersed with an aqueous continuous phase. Planar lamellar phases are generally less well suited to combine suspending solid material with preferred flow properties than are lamellar droplets, but they are nevertheless eminently suitable for thickening the product or endowing it with other consumer-preferred properties.

Concentrated liquid detergent compositions are more efficient in use and require less package and transport costs per wash. However, the high concentration of ingredients is often problematic. One problem is to formulate an internally structured composition that is physically stable over a prolonged period of time as the highly concentrated surfactants tend to aggregate whereby phase seperation occurs. Moreover, because other ingredients in the composition are also present in high concentrations, these ingredients may also separate out themselves or cause other ingredients to become insoluble.

One preferred embodiment of the present invention provides a structured detergent composition comprising

(a) from 1 to 90% preferably, from 10 to 70% of an anionic, nonionic, cationic, zwitterionic active detergent material or mixtures thereof,

(b) from 1 to 60% of a salting out electrolyte;

(c) from 0.001 to 10% of protease;

(d) from 2 to 40% of at least one saccharide selected from the group consisting of disaccharides and trisaccharides, derivatives thereof and mixtures thereof;

(e) 0 to 10% of deflocculating polymer; and

(f) less than 3% of an antioxidant selected from the group consisting of alkalimetalsulphites, alkalimetalbisulphites, alkalimetabisulphites or alkalimetalthiosulphates.

The structured composition comprises less than 3 wt %, more preferably less than 2 wt %, most preferably less than 1 wt % of the antioxidant.

### IIb Clarity

If the composition is lamellar structured, than the composition is preferably substantially unclear. Preferably, this means that the composition as an optical transmissivity of at less than 5% through a path length of 1 cm at 25° C. These measurements may be obtained using a Perkin Elmer UV/VIS Spectrometer Lambda 12 or a Brinkman PC801 Colorimeter at a wavelength of 520 nm, using water as the 100% standard.

### IIc Surfactant

The structured compositions herein comprise from 1 to 90% by weight of an anionic, nonionic, cationic, zwitterionic active detergent material or mixtures thereof.

In the event that the structured composition is lamellar structured, the clarity of the lamellar phase may be controlled by choosing an appropriate surfactant or blend of surfactants. One suitable approach is to include aralkyl surfactants such as alkyl benzene sulphonates, i.e. the total of aralkyl surfactants should more than 1%, preferably more than 5%, more preferably more than 10%, and especially more than 30% by weight of the total surfactants (including any soap).

To formulate a surfactant blend suitable for forming a lamellar phase without using aralkyl materials, one may, for example, employ a blend of primary and/or secondary alkane sulphate or sulphonate material together with one or more nonionic surfactants.

Examples of suitable alkane sulph(on)ates are sodium and potassium alkyl sulphates, especially those obtained by sulphonating higher (C₈-C₁₈), primary or secondary alcohols produced, for example, from tallow or coconut oil.

Suitable nonionic surfactants include, in particular, the reaction products of compounds having a hydrophobic group and reactive hydrogen atom, for example aliphatic alcohols, acids, amides with alkylene oxides, especially ethylene oxide, either alone or with propylene oxide. Specific nonionic detergent compounds are alkyl (C₆-C₁₈) primary or secondary linear or branched alcohols with ethylene oxide, and products made by condensation of ethylene oxide with the reaction products of propylene oxide and ethylenediamine. Other so-called nonionic detergent compounds include long chain tertiary amine oxides, long-chain tertiary phosphine oxides and dialkyl sulphoxides.

Preferably, the weight ratio at the total alkane sulph(on)ate material to the total nonionic material is from 90:10 to 10:90, more preferably from 80:20 to 50:50.

Another suitable surfactant blend for this purpose comprises one or more soaps with one or more nonionic surfactants.

Suitable soaps include alkali metal soaps of long chain mono- or dicarboxylic acids for example one having from 12 to 18 carbon atoms. Typical acids of this kind are oleic acid, ricinoleic acid and fatty acids derived from castor oil, rapeseed oil, groundnut oil, coconut oil, palm kernel oil or mixtures thereof. The sodium or potassium soaps of these acids can be used.

Suitable nonionic surfactants to blend with the soap are mentioned above. Preferably, the weight ratio of the total soap to the total nonionic material is from 60:40 to 90:10, more preferably from 70:30 to 80:20.

In other preferred structured compositions, part or all of the detergent active material is a stabilising surfactant, which has an average alkyl chain length greater then 6 C-atoms, and which has a salting out resistance, greater than, or equal to 6.4. These stabilising surfactants are disclosed in EP-A-328 177. Examples of these materials are alkyl polyalkoxylated phosphates, alkyl polyalkoxylated sulphosuccinates; dialkyl diphenyloxide disulphonates; alkyl polysaccharides and mixtures thereof. The advantage of these surfactants is that they are surfactants with a relatively low refractive index and these surfactants tend to decrease the droplet size of the lamellar droplets. Both effects have a positive effect on the clarity of the systems.

However, aside from any desire to formulate the surfactant content to control the clarity of the lamellar structured composition, in the widest sense, the detergent-active material in the structured composition, in general, may comprise one or more surfactants, and may be selected from anionic, cationic, nonionic, zwitterionic and amphoteric species, and (provided mutually compatible) mixtures thereof. For example, they may be chosen from any of the classes, sub-classes and specific materials described in ‘Surface Active Agents’ Vol. 1, by Schwartz & Perry, Interscience 1949 and ‘Surface Active Agents’ vol. 11 by Schwartz, Perry & Berch (Interscience 1958), in the current edition of “McCutcheon's Emulsifiers & Detergents” published by the McCutcheon division of Manufacturing Confectioners Company or in ‘Tensid-Taschenbuch”, H. Stache, 2nd Edn., Carl Hanser Verlag, Munchen & Wien, 1981.

In many (but not all) cases, the total detergent-active material may be preferably present at from 10% to 70% by weight of the total structured composition, for example from 12% to 60% and typically from 15% to 40% by weight. However, one preferred class of structured compositions comprises at least 15%, most preferably at least 25% and especially at least 30% of detergent-active material based on the weight of the total structured composition. In the case of blends of surfactants, the precise proportions of each component which will result in such stability and viscosity will depend on the type(s) and amount(s) of the electrolytes, as is the case with conventional structured liquids.

Common anionic surfactants are usually water-soluble alkali metal salts of organic sulphates and sulphonates having alkyl radicals containing from about 8 to 22 carbon atoms, the term alkyl being used to include the alkyl portion of higher acyl radicals.

Aside from anionic surfactants already mentioned with regard to refractive index control, where appropriate, one may still employ conventional sodium and potassium alkyl (C₉-C₂₀) benzene sulphonates, particularly sodium linear secondary alkyl (C₁₀-C₁₅) benzene sulphonates; sodium alkyl glyceryl ether sulphates, especially those ethers of the higher alcohols derived from tallow or coconut oil and synthetic alcohols derived from petroleum. Other suitable anionics include sodium coconut oil fatty monoglyceride sulphates and sulphonates; sodium and potassium salts of sulphuric acid esters of higher (C₆-C₁₈) fatty alcohol-alkylene oxide, particularly ethylene oxide, reaction products; the reaction products of fatty acids such as coconut fatty acids esterified with isethionic acid and neutralised with sodium hydroxide; sodium and potassium salts of fatty acid amides of methyl taurine; alkane monosulphonates such as those derived by reacting alpha-olefins (C₈₋₂₀) with sodium bisulphite and those derived from reacting paraffins with SO₂ and Cl₂ and then hydrolyzing with a base to produce a random sulphonate; and olefin sulphonates, which term is used to describe the material made by reacting olefins, particularly C₁₀-C₂₀ alpha-olefins, with SO₃ and then neutralising and hydrolyzing the reaction product.

### IId Deflocculating Polymer

In one preferred embodiment of the present invention when the composition is structured, the composition comprises from 0 to 10% of deflocculating polymer.

According to the specification of EP-A-346 995, the dependency of stability and/or viscosity upon volume fraction is favourably influenced by incorporating into the lamellar dispersion, a deflocculating polymer comprising a hydrophilic backbone and one or more hydrophobic side-chains.

The theory of function of these deflocculating polymers is that the hydrophobic chains are anchored in the outer bilayer of the lamellar droplet. The hydrophilic part is extended outwards. These hydrophilic ‘brushes’ are responsible for the steric stabilisation of the droplets, provided that the ‘brushes’ exceed a certain length. For surfactant blends in common use, the optimum length of the polymer hydrophobic chain, in order to be anchored into the bilayer is in the order of C₁₂-C₁₅, about the length of the surfactants in the droplet.

Thus, it is already well known to incorporate deflocculating polymers in aqueous liquid detergents which are structured with lamellar droplet dispersions. However, in these conventional structured compositions, the polymer is incorporated in a base composition (i.e. the same composition without the polymer) which is already stable and pourable. EP-A-346 995 defines, in practical terms, the conventional deflocculating effect as that of a polymer in a stable and pourable composition whereby the equivalent composition minus the deflocculating polymer, has a significantly higher viscosity and/or becomes unstable.

Preferably, the term “does not have significantly higher viscosity” means that a shear rate of 21s¹, the difference in viscosity is no more than 500 mPa.s, preferably no more than 250 mPa.s.

Preferably, the term “stable” means that the structured liquid detergent composition yields no more than 2% by volume visible phase separation when stored at 25° C. for 21 days from the time of preparation, more preferably less than 0.1% by volume visible phase separation when stored at 25° C. for 90 days from the time of preparation. Structured liquid detergent compositions according to the present invention are preferably “stable” according to these definitions.

Thus, when any structured composition according to the present invention comprises deflocculating polymer this may comprise one or more deflocculating polymer materials according to EP-A 346 995 and/or as recited herein below.

Generally, the amount of material of deflocculating polymer in a composition according to any aspect of the invention will be from 0.01% to 5.0% by weight in the structured composition, most preferably from 0.1% to 2.0%.

For example, EP-A-438 215 discloses preparation of acrylic acid telomers with a functional terminal group, using a secondary alcohol chain transfer agent which may, for example be a C₆-C₁₂ monofunctional secondary alcohol. These materials are described as detergent additives, in particular sequestrants or anti-precipitants. The materials are produced using polymerisation initiators such as ditertiary butyl peroxide. In the description of various different possible initiators, there is mentioned lauryl peroxide.

Some specific kinds of deflocculating polymers which contain only one hydrophobic moiety and which is attached to an end position of a hydrophilic chain, are disclosed in EP-A-623 670.

Various sub-types are described for the deflocculating polymers in EP-A-623 670. However, many of those actually exemplified are thiol polyacrylates, that is to say, materials formed by polymerisation of acrylic acid in the presence of a hydrophobic chain transfer agent having from five to twenty five carbon atoms and a terminal-SH group, in a radical polymerisation process. Analagous materials having a thia linkage between the hydrophilic and hydrophobic parts of the molecule are disclosed in U.S. Pat. No. 5,489,395, U.S. Pat. No. 5,489,397 and EP-A-691 399.

Another class of suitable deflocculating polymers comprises oligomers or polymers of formula (I) as disclosed in our international patent application WO-A-98/55576.

### IIe Electrolyte

Although it is possible to form lamellar dispersions of surfactant in water alone, in many cases it is preferred for the aqueous continuous phase to contain dissolved electrolyte. As used herein, the term electrolyte means any ionic water-soluble material. However, in lamellar dispersions, not all the electrolyte is necessarily dissolved but may be suspended as particles of solid because the total electrolyte concentration of the liquid is higher than the solubility limit of the electrolyte. Mixtures of electrolytes also may be used, with one or more of the electrolytes being in the dissolved aqueous phase and one or more being substantially only in the suspended solid phase. Two or more electrolytes may also be distributed approximately proportionally, between these two phases. In part, this may depend on processing, e.g. the order of addition of components. On the other hand, the terms ‘salts’ includes all organic and inorganic materials which may be included, other than surfactants and water, whether or not they are ionic, and this term encompasses the sub-set of the electrolytes (water-soluble materials).

However, there is a limit to the size and amount of non-dissolved (i.e. suspended) electrolytes in these formulation which is consistent with the objective of clarity. The amount of small particles which are not visible as separate entities should be so low that the bulk of the liquid remains substantially clear in accordance with the definition of the first aspect of the present invention. The amounts of relatively large particles (i.e. visible as separate entities) should be such that they have a pleasing visual effect like the aforementioned “visible solids”.

The only restriction on the total amount of detergent-active material and electrolyte (if any) is that in the structured compositions of the invention, together they must result in formation of an aqueous lamellar dispersion. Thus, within the eambit of the present invention, a very wide variation in surfactant types and levels is possible. The selection of surfactant types and their proportions, in order to obtain a stable liquid with the required structure will be fully within the capability of those skilled in the art.

Preferably, the structured compositions contain from 1% to 60%, especially from 10 to 45% of a salting-out electrolyte. Salting-out electrolyte has the meaning ascribed to in specification EP-A-79 646. Optionally, some salting-in electrolyte (as defined in the latter specification) may also be included, provided if of a kind and in an amount compatible with the other components and the structured composition is still in accordance with the definition of the invention claimed herein. Some or all of the electrolyte (whether salting-in or salting-out), or any substantially water-insoluble salt which may be present, may have detergency builder properties. In any event, it is preferred that structured compositions according to the present invention include detergency builder material, some or all of which may be electrolyte. The builder material is any capable of reducing the level of free calcium ions in the wash liquor and will preferably provide the structured composition with other beneficial properties such as the generation of an alkaline pH, the suspension of soil removed from the fabric and the dispersion of the fabric softening clay material.

### IIf Detergency Builder

As already mentioned, water soluble inorganic detergency builders (if dissolved in the aqueous phase) are electrolytes but any solid material above the solubility limit will normally be suspended by the lamellar phase.

Examples of phosphorous-containing inorganic detergency builders, when present, include the water-soluble salts, especially alkali metal pyrophosphates, orthophosphates, polyphosphates and phosphonates. Specific examples of inorganic phosphate builders include sodium and potassium tripolyphosphates, phosphates and hexametaphosphates. Phosphonate sequestrant builders may also be used.

Examples of non-phosphorous-containing inorganic detergency builders, when present, include water-soluble alkali metal carbonates, bicarbonates, silicates and crystalline and amorphous aluminosilicates. Specific examples include sodium carbonate (with or without calcite seeds), potassium carbonate, sodium and potassium bicarbonates, silicates and zeolites, although there are restrictions with respect to the amount and volume fraction of solid particles which can be added while retaining substantial clarity.

In the context of inorganic builders, we prefer to include electrolytes which promote the solubility of other electrolytes, for example use of potassium salts to promote the solubility of sodium salts. Thereby, the amount of dissolved electrolyte can be increased considerably (crystal dissolution) as described in UK patent specification GB 1 302 543.

Examples of organic detergency builders, when present, include the alkaline metal, ammonium and substituted ammonium polyacetates, carboxylates, polycarboxylates, polyacetyl carboxylates, carboxymethyloxysuccinates, carboxymethyloxymalonates, ethylene diamine-N,N-disuccinic acid salts, polyepoxysuccinates, oxydiacetates, triethylene tetramine hexa-acetic acid salts, N-alkyl imino diacetates or dipropionates, alpha sulpho-fatty acid salts, dipicolinic acid salts, oxidised polysaccharides, polyhydroxysulphonates and mixtures thereof.

Specific examples include sodium, potassium, lithium, ammonium and substituted ammonium salts of ethylenediamino-tetraacetic acid, nitrilo-triacetic acid, oxydisuccinic acid, melitic acid, benzene polycarboxylic acids and citric acid, tartrate mono succinate and tartrate di succinate.

In the context of organic builders, it is also desirable to incorporate polymers which are only partly dissolved in the aqueous continuous phase. This allows a viscosity reduction (owing to the polymer which is dissolved whilst incorporating a sufficiently high amount to achieve a secondary benefit, especially building, because the part which is not dissolved does not bring about the instability that would occur if substantially all were dissolved). As for inorganic builders, the same restrictions apply with respect to the amount and volume fraction of non-dissolved polymer phase which can be added while retaining substantial clarity.

### IIg Other Polymers

Examples of partly dissolved polymers include many of the polymer and co-polymer salts already known as detergency builders. For example, may be used (including building and non-building polymers) polyethylene glycols, polyacrylates, polymaleates, polysugars, polysugarsulphonates and co-polymers of any of these. Preferably, the partly dissolved polymer comprises a co-polymer which includes an alkali metal salt of a polyacrylic, polymethacrylic or maleic acid or anhydride. Preferably, structured compositions with these co-polymers have a pH of above 8.0 In general, the amount of viscosity-reducing polymer can vary widely according to the formulation of the rest of the structured composition. However, typical amounts are from 0.5 to 4.5% by weight.

It is further possible to include in the structured compositions of the present invention, alternatively, or in addition to the partly dissolved polymer, yet another polymer which is substantially totally soluble in the aqueous phase and has an electrolyte resistance of more than 5 grams sodium nitrilotriacetate in 100 ml of a 5% by weight aqueous solution of the polymer, said second polymer also having a vapour pressure in 20% aqueous solution, equal or less than the vapour pressure of a reference 2% by weight or greater aqueous solution of polyethylene glycol having an average molecular weight of 6,000; said second polymer having a molecular weight of at least 1,000.

The incorporation of the soluble polymer permits formulation with improved stability at the same viscosity (relative to the structured composition without the soluble polymer) or lower viscosity with the same stability. The soluble polymer can also reduce viscosity drift, even when it also brings about a viscosity reduction. Here, improved stability and lower viscosity mean over and above any such effects brought about by the deflocculating polymer.

It is especially preferred to incorporate the soluble polymer with a partly dissolved polymer which has a large insoluble component. That is because although the building capacity of the partly dissolved polymer will be good (since relatively high quantities can be stably incorporated), the viscosity reduction will not be optimum (since little will be dissolved). Thus, the soluble polymer can usefully function to reduce the viscosity further, to an ideal level.

The soluble polymer can, for example, be incorporated at from 0.05 to 20% by weight, although usually from 0.1 to 10% by weight of the total structured composition is sufficient, and especially from 0.2 to 3.5-4.5% by weight. It has been found that the presence of deflocculating polymer increase the tolerance for higher levels of soluble polymer without stability problems. A large number of different polymers may be used as such a soluble polymer, provided the electrolyte resistance and vapour pressure requirements are met. The former is measured as the amount of sodium nitrolotriacetate (NaNTA) solution necessary to reach the cloud point of 100 ml of a 5% w/w solution of the polymer in water at 25° C., with the system adjusted to neutral pH, i.e. about 7. This is preferably effected using sodium hydroxide. Most preferably, the electrolyte resistance is 10 g NaNTA, especially 15 g. The latter indicates a vapour pressure low enough to have sufficient water binding capability, as generally explained in the applicants' specification GB-A-2 053 249. Preferably, the measurement is effected with a reference solution at 10% by weight aqueous concentration, especially 18%.

Typical classes of polymers which may be used as the soluble polymer, provided they meet the above requirements, include polyethylene glycols, Dextran, Dextran sulphonates, polyacrylates and polyacrylate/maleic acid co-polymers.

The soluble polymer must have an average molecular weight of at least 1,000 but a minimum average molecular weight of 2,000 is preferred.

The use of partly soluble and the use of soluble polymers as referred to above in detergent compositions is described in our European patent specifications EP-A-301 882 and EP-A-301 883.

### IIh Hydrotropes

Although it is possible to incorporate minor amounts of hydrotropes such as lower alcohols (e.g. ethanol) or alkanolamines (e.g. triethanolamine), in order to ensure integrity of the lamellar dispersion we prefer that the structured compositions of the present invention are substantially free from hydrotropes. By hydrotrope is meant any water soluble agent which tends to enhance the solubility of surfactants in aqueous solution.

### III Liquid Detergents in General

The liquid detergent composition according the invention being either isotropic or structured may contain additional optional ingredients

### Optional Ingredients

The compositions herein can further comprise a variety of optional ingredients. A wide variety of other ingredients useful in detergent compositions can be included in the compositions herein, including other active ingredients, carriers, hydrotropes, processing aids, dyes or pigments, solvents for liquid formulations, solid fillers for bar compositions, etc. If high sudsing is desired, suds boosters such as the C10-C16 alkanolamides can be incorporated into the compositions, typically at 1%-10% levels. The C10-C14 monoethanol and diethanol amides illustrate a typical class of such suds boosters. Use of such suds boosters with high sudsing; adjunct surfactants such as the amine oxides, betaines and sultaines noted above is also advantageous. If desired, soluble magnesium salts such as MgC12, MgS04, and the like, can be added at levels of, typically,0.1%-2%, to provide additional suds and to enhance grease removal performance.

Various detersive ingredients employed in the present compositions optionally can be further stabilized by absorbing said ingredients onto a porous hydrophobic substrate, then coating said substrate with a hydrophobic coating. Preferably, the detersive ingredient is admixed with a surfactant before being absorbed into the porous substrate. In use, the detersive ingredient is released from the substrate into the aqueous washing liquor, where it performs its intended detersive function.

By this means, ingredients such as the aforementioned, bleaches, bleach activators, bleach catalysts, photoactivators, dyes, fluorescers, fabric conditioners and hydrolyzable surfactants can be “protected” for use in detergents, including liquid laundry detergent compositions.

Liquid detergent compositions can contain water and other solvents as carriers.

### Chelating Agents

The detergent compositions herein may also optionally contain one or more iron and/or manganese chelating agents. Such chelating agents can be selected from the group consisting of amino carboxylates, amino phosphonates, polyfanctionally-substituted aromatic chelating agents and mixtures therein, all as hereinafter defined.

If utilized, these chelating agents will generally comprise from about 0.1% to about 10% by weight of the detergent compositions herein. More preferably, if utilized, the chelating agents will comprise from about 0.1% to about 3.0% by weight of such compositions.

### Clay Soil Removal/anti-redeposition Agents

The compositions of the present invention can also optionally contain water- soluble ethoxylated amines having clay soil removal and antiredeposition properties.

Liquid detergent compositions typically contain about 0.01% to about 5% of these agents.

One preferred soil release and anti-redeposition agent is ethoxylated tetraethylenepentamine. Exemplary ethoxylated amines are further described in U.S. Pat. No. 4,597,898,

Another type of preferred antiredeposition agent includes the carboxy methyl cellulose (CMC) materials. These materials are well known in the art.

### Brightener

Any optical brighteners or other brightening or whitening agents known in the art can be incorporated at levels typically from about 0.05% to about 1.2%, by weight, into the detergent compositions herein. Commercial optical brighteners which may be useful in the present invention can be classified into subgroups, which include, but are not necessarily limited to, derivatives of stilbene, pyrazoline, coumarin, carboxylic acid, methinecyanines, dibenzothiphene-5,5-dioxide, azoles, 5- and 6-membered- ring heterocycles, and other miscellaneous agents. Examples of such brighteners are disclosed in “The Production and Application of Fluorescent Brightening Agents”, M. Zahradnik, Published by John Wiley & Sons, New York (1982).

### Suds Suppressors

Compounds for reducing or suppressing the formation of suds can be incorporated into the compositions of the present invention. Suds suppression can be of particular importance in the so-called “high concentration cleaning process” as described in U.S. Pat. Nos. 4,489,455 and 4,489,574 and infront-loading European-style washing machines.

A wide variety of materials may be used as suds suppressors, and suds suppressors are well known to those skilled in the art. See, for example, Kirk Othmer Encyclopedia of Chemical Technology, Third Edition, Volume 7, pages 430-447 (John Wiley & Sons, Inc., 1979). One category of suds suppressor of particular interest encompasses monocarboxylic fatty acid and soluble salts therein. See U.S. Pat. No. 2,954,347. The monocarboxylic fatty acids and salts thereof used as suds suppressor typically have hydrocarbyl chains of 10 to about 24 carbon atoms, preferably 12 to 18 carbon atoms. Suitable salts include the alkali metal salts such as sodium, potassium, and lithium salts, and ammonium and alkanolammonium salts.

The detergent compositions herein may also contain non-surfactant suds suppressors. These include, for example: high molecular weight hydrocarbons such as paraffin, fatty acid esters (e.g., fatty acid triglycerides), fatty acid esters of monovalent alcohols, aliphatic C18-C40 ketones (e.g., stearone), etc.

The preferred category of non-surfactant suds suppressors comprises silicone suds suppressors. This category includes the use of polyorganosiloxane oils, such as polydimethylsiloxane, dispersions or emulsions of polyorganosiloxane oils or resins, and combinations of polyorganosiloxane with silica particles wherein the polyorganosiloxane is chemisorbed or fused onto the silica. Silicone suds suppressors are well known in the art and are, for example, disclosed in U.S. Pat. No. 4,265,779.

For any detergent compositions to be used in automatic laundry washing machines, suds should not form to the extent that they overflow the washing machine.

Suds suppressors, when utilized, are preferably present in a “suds suppressing amount.

By “suds suppressing amount” is meant that the formulator of the composition can select an amount of this suds controlling agent that will sufficiently control the suds to result in a low-sudsing laundry detergent for use in automatic laundry washing machines.

The compositions herein will generally comprise from 0.1% to about 5% of suds suppressor.

### Fabric Softners

Various through-the-wash fabric softeners, especially the impalpable smectite clays of U.S. Pat. No. 4,062,647 as well as other softener clays known in the art, can optionally be used typically at levels of from about 0.5% to about 10% by weight in the present compositions to provide fabric softener benefits concurrently with fabric cleaning. Clay softeners can be used in combination with amine and cationic softeners as disclosed, for example, in U.S. Pat. No. 4,375,416 and U.S. Pat. No. 4,291,071.

### Dye Transfer Inhibiting Agents

The compositions of the present invention may also include one or more materials effective for inhibiting the transfer of dyes from one fabric to another during the cleaning process. Generally, such dye transfer inhibiting agents include polyvinyl pyrrolidone polymers, polyamine N-oxide polymers, copolymers of N-vinylpyrrolidone and N-vinylimidazole, manganese phthalocyanine, peroxidases, and mixtures thereof. If used, these agents typically comprise from about 0.01% to about 10% by weight of the composition, preferably from about 0.01% to about 5%, and more preferably from about 0.05% to about 2%.

Other than in the examples, or where otherwise indicated, all numbers expressing quantities of ingredients or reaction conditions used herein are to be understood as modified in all instances by the term “about”. Similarly, all percentages are weight/weight percentages of the carbon dioxide unless otherwise indicated. Where the term “comprising” is used in the specification or claims, it is not intended to exclude any terms, steps or features not specifically recited.

### EXAMPLES

Example 1-4 and Comparative Example A (Concentrated isotropic liquid detergent compositions).

The following composition was prepared with different levels of carbohydrate and borate.

| Component | % w/w |
|---|---|
| Na-Linear Alkyl benzene sulphonate | 7.0 |
| Na LES | 11.6 |
| Alcohol ethoxylate (Synperonic A7) | 7.0 |
| Carbohydrate | see table |
| Na-Borate.5aq | see table |
| Na-citrate | 5.0 |
| Propylene glycol (mostly from NaLES) | 3.42 |
| Mono Ethanol Amine | 0.24 |
| Coconut Fatty Acid | 0.85 |
| Protease (Purafect 4000L) | 0.3 |
| NaOH to pH | 8.0 |
| Water and minors | up to 100% |

### Enzyme Stability Results

The enzyme stability results are given in the table below.

| % | A | 1 | 2 | 3 | 4 |
|---|---|---|---|---|---|
| Carbo- | 0 | 20 | 0 | 10 | 10 |
| hydrate | | | | | |
| Borate | 0 | 0 | 1 | 1 | 2 |
| Protease | 2 | 50 | 29 | 57 | 72 |
| % Rest- | | | | | |
| Activity | | | | | |

(Carbohydrate = sucrose)

The comparative example A and examples 1-4 according the invention were stored for 2 weeks at 37° C. After this period the rest activity of the enzyme was determined. All compositions were physically stable after this period. The results of the examples 1-4 according the invention demonstrate that carbohydrate can improve protease stability quite considerably, while the composition remains physically stable.

### Examples 5 and 6 and Comparative Example B and C

The following compositions were prepared to determine the effect of sulphite salt on the physical stability of the liquid detergent compositions.

| | B | C | 5 | 6 |
|---|---|---|---|---|
| Na-Linear Alkyl benzene | 7.0 | 7.0 | 7.0 | 7.0 |
| sulphonate | | | | |
| NaLES | 11.6 | 11.6 | 11.6 | 11.6 |
| Alcohol ethoxylate | 7.0 | 7.0 | 7.0 | 7.0 |
| Synperonic A7 | | | | |
| NaBorate | 2 | 2 | 2 | 2 |
| Carbohydrate | 2 | 10 | 2 | 10 |
| Sulphite | 5 | 5 | 0 | 0 |
| Na-Citrate | 5 | 5 | 5 | 5 |
| Propylene glycol | 3.42 | 3.42 | 3.42 | 3.42 |
| MEA | 0.24 | 0.24 | 0.24 | 0.24 |
| Coconut fatty acid | 0.85 | 0.85 | 0.85 | 0.85 |
| Purafect 4000L | 0.3 | 0.3 | 0.3 | 0.3 |
| Lipolase 100 LEX | 0.4 | 0.4 | 0.4 | 0.4 |
| NaOH to pH | 8.0 | 8.0 | 8.0 | 8.0 |
| Water to 100% | to 100% | to 100% | to 100% | To 100% |

(Carbohydrate = sucrose)

Comparative examples B and C with the minimal level of sulphite of 5 wt % as disclosed in U.S. Pat. No. 4,462,922 were physically unstable and had a hazy appearance. Comparative examples B and C were not isotropic. Examples 5 and 6 according the invention were isotropic and physically stable.

1. A liquid detergent composition comprising
(a) from 1 to 90% of an anionic, nonionic, cationic, zwitterionic active detergent material or mixtures thereof,
(b) from 0.001 to 10% of dissolved or dispersed protease;
said composition further comprising a protease stabilisation system wherein said system comprises
(c) from 2 to 40% of at least one saccharide selected from the group consisting of disaccharides and trisaccharides, derivatives thereof and mixtures thereof.

2. The composition of claim 1, wherein the composition comprises 10 to 70 wt % of detergent material..

3. The composition of claim 1, wherein the composition further comprises more than 0.1 and less than 5% of a boron compound, preferably less than 3%, more preferably less than 2.5%.

4. The composition of claim 1, wherein the composition comprises 15 to 40 wt % of detergent material.

5. The composition of claim 1, wherein the composition further comprises at least 0.0001% to 10% of an enzyme selected from the group consisting lipase, cellulase, peroxidase amylase and mixtures thereof.

6. The composition of claim 1, wherein the composition comprises 5 to 30%, preferably 8 to 25% of the saccharide.

7. The composition of claim 1, wherein the saccharide comprises sucrose or trehalose.

8. The composition of claim 1, wherein the said composition is an isotropic liquid detergent composition.

9. The composition of claim 1, wherein the said composition is a structured detergent composition comprising
(a) from 1 to 90% preferably, from 10 to 70% of an anionic, nonionic, cationic, zwitterionic active detergent material or mixtures thereof,
(b) from 1 to 60% of a salting out electrolyte;
(c) from 0.001 to 10% of protease;
(d) from 2 to 40% of at least one saccharide selected from the group consisting of disaccharides and trisaccharides, derivatives thereof and mixtures thereof;
(e) 0 to 10% of deflocculating polymer; and
(f) less than 3% of an antioxidant selected from the group consisting of alkalimetalsulphites, alkalimetalbisulphites, alkalimetabisulphites or alkalimetalthiosulphates.

10. A method for the stabilisation of protease in a physically stable liquid detergent composition, the method comprising the steps of
(I) formulating said composition comprising
(a) from 1 to 90% of an anionic, nonionic, cationic, zwitterionic active detergent material or mixtures thereof,
(b) from 0.0001% to 10% of dissolved or dispersed protease; and
(II) adding 2 to 40% of at least from 2 to 40% of at least one saccharide selected from the group consisting of disaccharides and trisaccharides, derivatives thereof and mixtures thereof to the composition prepared in step (I).

11. The method of claim 8 characterised in that the composition is a liquid detergent composition comprising
(a) from 1 to 90% of an anionic, nonionic, cationic, zwitterionic active detergent material or mixtures thereof,
(b) from 0.001 to 10% of dissolved or dispersed protease;
said composition further comprising a protease stabilisation system wherein said system comprises
(c) from 2 to 40% of at least one saccharide selected from the group consisting of disaccharides and trisaccharides, derivatives thereof and mixtures thereof.
